(19) United States
(12) Patent Application Publication
(10) Pub. No.: US 2025/0318504 A1
(43) Pub. Date: Oct. 16, 2025

(54) Solar-Powered GNSS SIM Chip Device for Tracking and Monitoring Animals and Assets

(71) Applicant: Andy Doyle Jones, Edmond, OK (US)

(72) Inventor: Andy Doyle Jones, Edmond, OK (US)

(21) Appl. No.: 19/247,834

(22) Filed: Jun. 24, 2025

Related U.S. Application Data
(63) Continuation-in-part of application No. 17/809,880, filed on Jun. 29, 2022, now Pat. No. 12,336,501.
Application No. 17/809,880 is a continuation-in-part of application No. 17/196,993, filed on Mar. 9, 2021, now Pat. No. 11,503,802.
Application No. 17/196,993 is a continuation-in-part of application No. 16/815,280, filed on Mar. 11, 2020, now Pat. No. 10,939,665.
Application No. 16/815,280 is a continuation-in-part of application No. 16/727,736, filed on Dec. 26, 2019, now Pat. No. 10,945,097.
Application No. 17/809,880 is a continuation-in-part of application No. 17/196,987, filed on Mar. 9, 2021, now abandoned.
Application No. 17/196,987 is a continuation-in-part of application No. 16/727,736, filed on Dec. 26, 2019, now Pat. No. 10,945,097.
(60) Provisional application No. 62/896,985, filed on Sep. 6, 2019.
(60) Provisional application No. 62/896,985, filed on Sep. 6, 2019.
(60) Provisional application No. 63/216,122, filed on Jun. 29, 2021.

(51) Int. Cl. A01K 11/00; G06K 19/07; H04M 1/02; H04W 4/029

(52) U.S. Cl. CPC A01K 11/004; G06K 19/0723; H04M 1/0264; H04M 1/0274; H04W 4/029; H04M 2250/10; H04M 2250/52

(57) ABSTRACT

A solar-powered Global Navigation Satellite System (GNSS) Subscriber Identity Module (SIM) chip device for tracking and monitoring animals and assets is disclosed that allows an individual to track an animal or object. The device is designed as an ultra-low power and lightweight tag that runs only when needed. To do so, the device includes an electronic ear tag, a cellular communication module, a camera module, an electronic stethoscope, a radio-frequency identification (RFID) scannable chip, and a two-way audio communication system. The electronic ear tag corresponds to the main structure of the device that supports the operation of the electrical and electronic components. The cellular communication module enables the device to connect to a cellular network through which the necessary data is being transmitted. The camera module, the electronic stethoscope, the RFID scannable chip, and the two-way audio communication system facilitate the remote monitoring of the target animal wearing the device.

The current application is a continuation-in-part (CIP) application of a U.S. non-provisional application Ser. No. 17/809,880 filed on Jun. 6, 2022.

The U.S. non-provisional application Ser. No. 17/809,880 claims a priority to a U.S. provisional application Ser. No. 63/216,122 filed on Jun. 29, 2021.

The U.S. non-provisional application Ser. No. 17/809,880 is also a continuation-in-part (CIP) application of a U.S. non-provisional application Ser. No. 17/196,993 filed on Mar. 9, 2021. The U.S. non-provisional application Ser. No. 17/196,993 is a CIP application of a U.S. non-provisional application Ser. No. 16/815,280 filed on Mar. 11, 2020. The U.S. non-provisional application Ser. No. 16/815,280 claims a priority to the U.S. non-provisional application Ser. No. 16/727,736 filed on

Dec. 26, 2019 and also claims a priority to the U.S. Provisional Patent application Ser. No. 62/896,985 filed on Sep. 6, 2019.

The U.S. non-provisional application Ser. No. 17/809,880 is also a CIP application of a U.S. non-provisional application Ser. No. 17/196,987 filed on Mar. 9, 2021. The U.S. non-provisional application Ser. No. 17/196,987 filed on Mar. 9, 2021 is a

CIP application of a U.S. non-provisional application Ser. No. 16/727,736 filed on Dec. 26, 2019. The U.S. non-provisional application Ser. No. 16/727,736 claims a priority to the U.S. Provisional Patent application Ser. No. 62/896,985 filed on Sep. 6, 2019.

### FIELD OF THE INVENTION

The present invention generally relates to Global Navigation Satellite System (GNSS) devices, animal husbandry, electronic tagging, and wireless tracking. More specifically, the present invention discloses a highly-advanced-to-basic satellite tracking and monitoring device of livestock.

### BACKGROUND OF THE INVENTION

Nowadays, there are different systems and mechanisms available to help track and monitor different objects and livestock in the wild or in controlled systems. For livestock, several electronic devices are available, such as electronic ear tags that can be worn by the target animal that help owners and/or caretakers to track the target animal. While useful, these electronic ear tags have several limitations that prevent the continuous tracking of the target animal as well as the monitoring of the animal's wellbeing. For example, currently available electronic ear tags are not able to facilitate the remote monitoring of the well-being of the target animal by tracking different animal health vitals. This would require direct monitoring of the target animal or the implementation of another system that would allow the remote monitoring of the desired vitals. Therefore, an electronic device that enables the remote tracking and monitoring of a target animal is beneficial.

The objective of the present invention is to provide a solar-powered Global Navigation Satellite System (GNSS) Subscriber Identity Module (SIM) chip device for tracking and monitoring animals and assets. The present invention discloses an electronic ear tag with wireless communication capabilities that can be safely and securely worn by the target animal. The present invention can include different wireless technologies that enable the transmission of collected data to/from the electronic ear tag for tracking and monitoring purposes. For example, the present invention is preferably equipped with GNSS technology that enables the remote tracking of the target animal wearing the electronic ear tag. In addition, the present invention includes health vital monitoring technologies that allow the remote monitoring of the target animal's wellbeing. Further, the wireless capabilities of the present invention can also enable the wireless pairing of the electronic ear tag with a portable computing device through which the user can track and monitor the target animal. Additional features and benefits of the present invention are further discussed the sections below.

### SUMMARY OF THE INVENTION

The present invention discloses a solar-powered Global Navigation Satellite System (GNSS) Subscriber Identity Module (SIM) chip device for tracking and monitoring animals and assets. The present invention is preferably provided as an electronic ear tag that monitors a wide range of animal factors of the target animal. The present invention is equipped with GNSS technology that enables the wireless transmission of data to/from the electronic ear tag of the present invention. Further, the electronic ear tag of the present invention can be designed for different light conditions as well as different weather conditions. The electronic ear tag of the present invention also includes different power technologies that allows continuous operation without direct connection to an external power source. Further, the wireless capabilities of the present invention also allows for the pairing of the electronic ear tag to a computing device, such as a smartphone, laptop, tablet computer, etc. Using the computing device, the user can perform various tasks including, but not limited to, tracking the target animal, monitoring the target animal's vitals, etc.

### BRIEF DESCRIPTION OF THE DRAWINGS

FIG. 1 is a top-front perspective view of the present invention thereof.

FIG. 2 is a bottom-rear perspective view of the present invention thereof.

FIG. 3 is a front view of the present invention thereof, wherein the present invention is shown without casing.

FIG. 4 is a rear view of the present invention thereof.

FIG. 5 is an exploded top-front perspective view of the present invention thereof.

FIG. 6 is a box diagram showing the electrical connections and the electronic connections of the present invention, wherein the electrical connections are shown in solid lines, and wherein the electronic connections are shown in dashed lines.

### DETAILED DESCRIPTION OF THE INVENTION

All illustrations of the drawings are for the purpose of describing selected versions of the present invention and are not intended to limit the scope of the present invention.

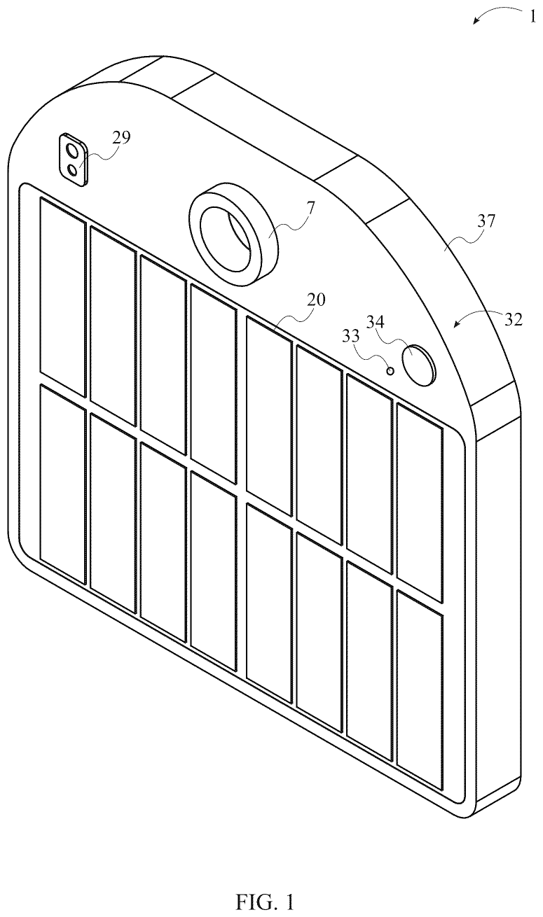

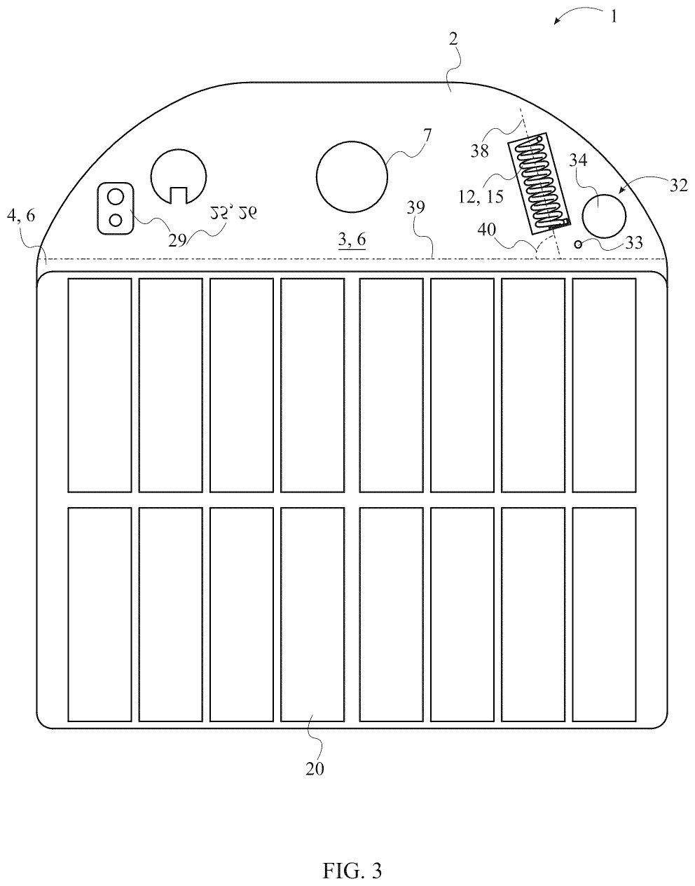

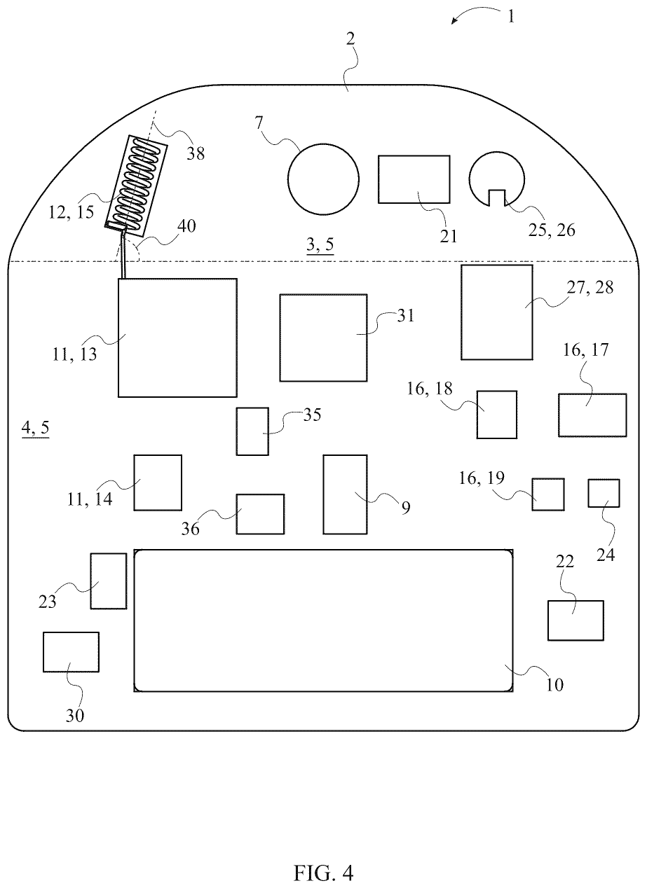

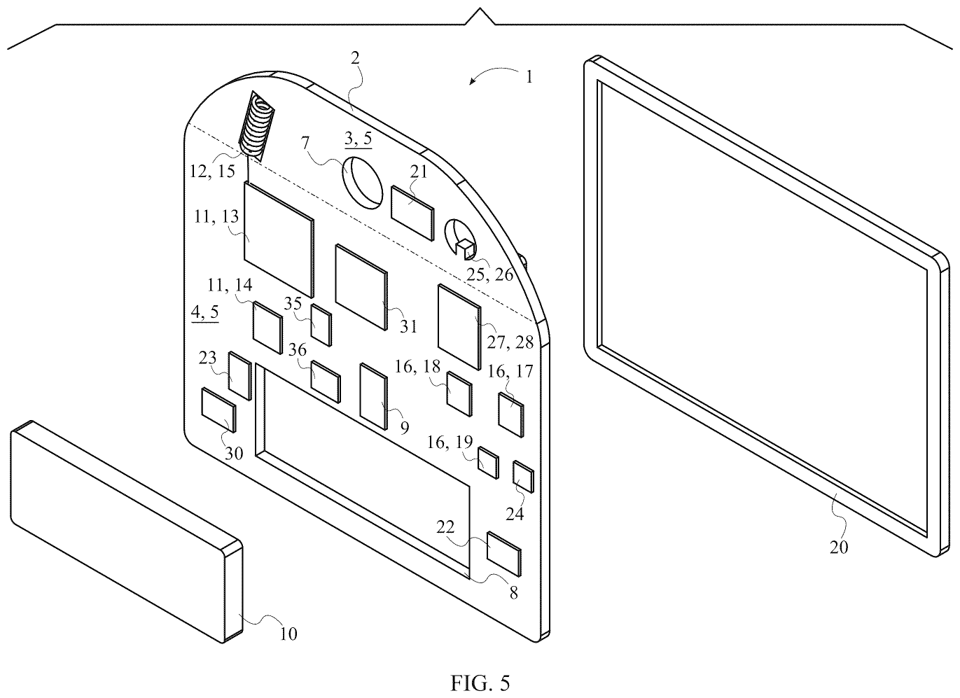

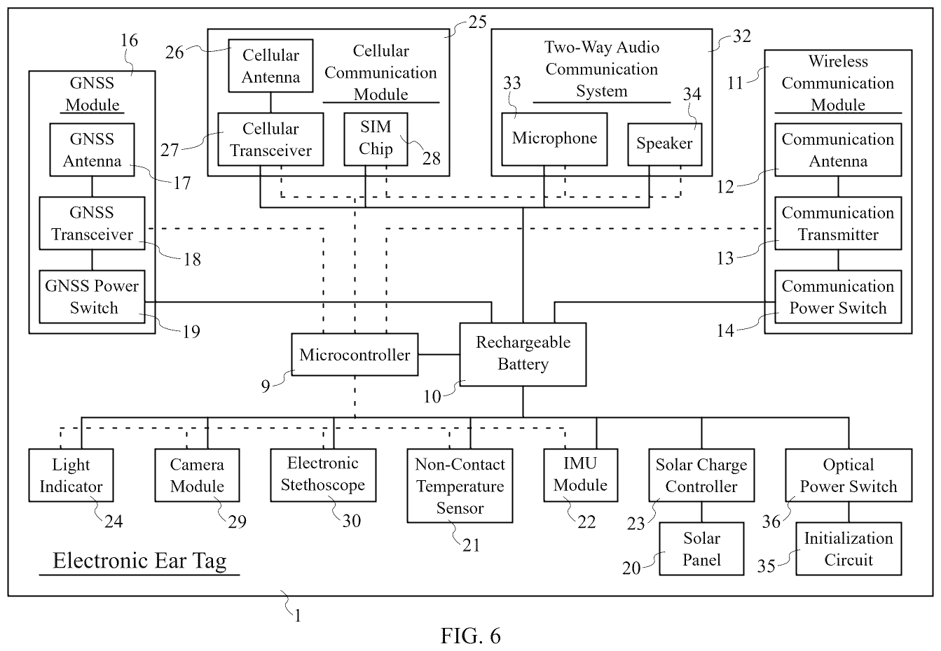

The present invention discloses a solar-powered Global Navigation Satellite System (GNSS) Subscriber Identity Module (SIM) chip device for tracking and monitoring animals and assets. The present invention is preferably provided as an electronic ear tag 1 that allows an individual to track an animal or object. The present invention is designed as an ultra-low power and lightweight tag that runs only when needed. As can be seen in FIGS. 1 through 6, the present invention comprises an electronic ear tag 1, a cellular communication module 25, a camera module 29, an electronic stethoscope 30, a Radio-Frequency Identification (RFID) scannable chip 31, and a two-way audio communication system 32. Generally, the electronic ear tag 1 corresponds to the main structure of the present invention that supports the operation of the electrical and electronic components. The cellular communication module 25 enables the present invention to connect to a cellular network through which the necessary data is being transmitted. The camera module 29, the electronic stethoscope 30, the RFID scannable chip 31, and the two-way audio communication system 32 facilitate the remote monitoring of the target animal wearing the electronic ear tag 1.

The general configuration of the aforementioned components enables the user to remotely track the location and movement of the target animal as well as to monitor the wellbeing of the target animal. As can be seen in FIGS. 1 through 6, the electronic ear tag 1 is preferably designed to be comfortably and securely attached to the animal's ear so that the target animal can be tracked and monitored using the present invention. So, the electronic ear tag 1 comprises a substrate 2, a microcontroller 9, a rechargeable battery 10, a wireless communication module 11, a Global Navigation Satellite System (GNSS) module 16, a solar panel 20, a non-contact temperature sensor 21, and an Inertial Measurement Unit (IMU) module 22.

As can be seen in FIGS. 1 through 6, the substrate 2 is preferably a circuit board used to support the electronic components of the present invention. The microcontroller 9 enables the automatic operation of the present invention by performing the corresponding computational processes locally. The rechargeable battery 10 is preferably a lithium polymer battery designed to maximize the battery yield and to distribute the weight of the present invention. Further, the wireless communication module 11 is preferably a wireless network radio module that allows communication with a wireless network. The GNSS module 16 allows communication with a GNSS satellite to determine the precise geographical location of the present invention. The solar panel 20 converts solar energy into electrical energy to recharge the rechargeable battery 10 whenever the present invention is exposed to sunlight. The non-contact temperature sensor 21 enables the remote monitoring of the target animal's body temperature. The IMU module 22 enables the tracking of the target animal's position and movement.

As can be seen in FIGS. 1 through 6, the substrate 2 further comprises a top flat portion 3, a bottom flat portion 4, and an ear-attachment feature 7. The ear-attachment feature 7 allows the present invention to be attached to the target animal's ear. The ear-attachment feature 7 may take different forms, sizes, and shapes that are appropriate for different animals. In addition, the top flat portion 3 and the bottom flat portion 4 each further comprises a first face 5 and a second face 6 corresponding to opposite flat surfaces of both the top flat portion 3 and the bottom flat portion 4. Further, to generally assemble the present invention, the substrate 2, the microcontroller 9, the rechargeable battery 10, the wireless communication module 11, the GNSS module 16, the solar panel 20, the non-contact temperature sensor 21, and the IMU module 22 are operatively coupled amongst each other. In other words, these electrical and electronic components are connected to each other in such a way that the transmission of electrical power and the electronic signals are transmitted between the corresponding components. Furthermore, the cellular communication module 25, the camera module 29, the IMU module 22, the electronic stethoscope 30, the RFID scannable chip 31, and the two-way audio communication system 32 are operatively integrated into the electronic ear tag 1 to form a single structure that can be attached to the target animal's ear. In some embodiments, the ear-attachment feature 7 may be an aperture which traverses through the substrate 2. In other embodiments, the ear-attachment feature 7 may include other mechanisms that facilitate the safe and secure attachment of the present invention to the target animal's ear.

As previously discussed, the present invention can connect to a cellular network to enable the wireless transmission of data that can be used to track and monitor the target animal. As can be seen in FIGS. 1 through 6, the cellular communication module 25 may comprise a cellular antenna 26, a cellular transceiver 27, and a Subscriber Identity Module (SIM) chip 28. The cellular antenna 26 and the cellular transceiver 27 facilitate the transmission of data via the cellular network. The SIM chip 28 authenticates the connection of the present invention to the cellular network. These components of the cellular communication module 25 can be implemented as follows: the cellular antenna 26 is integrated into the top flat portion 3 to secure the cellular antenna 26 to the substrate 2. The cellular transceiver 27 and the SIM chip 28 are also mounted onto the first face 5 of the bottom flat portion 4 to secure both the cellular transceiver 27 and the SIM chip 28 to the substrate 2. Further, the cellular transceiver 27 and the SIM chip 28 are electronically connected to the microcontroller 9 to enable the transmission of electronic signals between the cellular transceiver 27, the SIM chip 28, and the microcontroller 9. The cellular transceiver 27 is also electronically connected to the cellular antenna 26 to enable the wireless transmission of data processed by the cellular transceiver 27. Furthermore, the cellular transceiver 27, the SIM chip 28, and the microcontroller 9 are electrically connected to the rechargeable battery 10 to enable the distribution of electric power from the rechargeable battery 10. Note that the present invention can be implemented with a covering SIM chip 28. The covering of the SIM chip 28 allows for embedding the SIM chip 28 onto a board instead of a SIM card. In addition, the present invention is not limited to an embedded SIM chip 28 onto a board. For example, the SIM chip 28 can be used as an insertion and plugged into a cartridge and cover/screw over the insertion area for non-element proofing. This way, the present invention is utilized as a SIM or direct-from-device-to-satellite gateway. Other gateway methods can be implemented as well.

As previously discussed, the present invention is provided with a camera module 29 that is used to allow the user to visually see the surrounding area of the target animal wearing the present invention. As can be seen in FIGS. 1 through 6, the camera module 29 is preferably mounted onto the second face 6 of the top flat portion 3 which corresponds to the surface oriented away from the target animal. This way, the camera module 29 can capture the surroundings of the target animal when the present invention is attached to the animal's ear. Further, the camera module 29 is electronically connected to the microcontroller 9 to enable the transmission of electronic signals from the camera module 29 to the microcontroller 9 for processing. Furthermore, the camera module 29 is electrically connected to the rechargeable battery 10 to distribute the electrical power necessary for the operation of the camera module 29.

In the preferred embodiment, the electronic stethoscope 30 of the present invention is utilized to track the animal's heart and/or breathing to monitor the target animal's wellbeing. Unlike the camera module 29, the electronic stethoscope 30 is mounted onto the first face 5 of the bottom flat portion 4, as can be seen in FIGS. 1 through 6. This way, the electronic stethoscope 30 is oriented towards the target animal's body to track the desired health vitals. Further, the electronic stethoscope 30 is electronically connected to the microcontroller 9 to enable the transmission of electronic signals generated by the electronic stethoscope 30 to the microcontroller 9 for processing. Furthermore, the electronic stethoscope 30 is electrically connected to the rechargeable battery 10 to distribute the electrical power necessary for the operation of the electronic stethoscope 30.

In the preferred embodiment, the RFID scannable chip 31 is preferably a product of the United States Department of Agriculture (USDA) that utilizes a unique Identification (ID) number that enables the identification of the target animal. Like the camera module 29, the RFID scannable chip 31 is mounted onto the first face 5 of the bottom flat portion 4 which orients the RFID scannable chip 31 away from the target animal's body, as can be seen in FIGS. 1 through 6. This way, the user can easily access the RFID scannable chip 31 on the field. Furthermore, the RFID scannable chip 31 is peripherally positioned on the bottom flat portion 4 for easier access.

As can be seen in FIGS. 1 through 6, the two-way audio communication system 32 allows audio signals to be sent to and from the electronic ear tag 1 which enables different tasks to be performed. For example, the user can remotely send commands to the target animal via the corresponding electronic ear tag 1, listen to the surroundings of the target animal, or communicate with people adjacent to the target animal wearing the electronic ear tag 1. To do so, the two-way audio communication system 32 may comprise a microphone 33 and a speaker 34. The microphone 33 and the speaker 34 are mounted onto the second face 6 of the top flat portion 3 to secure the microphone 33 and the speaker 34 to the substrate 2. In addition, this orients the microphone 33 and the speaker 34 away from the target animal's body. Further, the speaker 34 and the microphone 33 are electronically connected to the microcontroller 9 to enable the transmission of audio signals. Furthermore, the microphone 33 and the speaker 34 are electrically connected to the rechargeable battery 10 to distribute the electrical power necessary for the operation of the microphone 33 and the speaker 34.

As can be seen in FIGS. 1 through 6, the substrate 2 may further comprise a battery cutout 8 that supports and contains the rechargeable battery 10 adjacent to the solar panel 20. To ingrate the battery cutout 8, the battery cutout 8 traverses through the bottom flat portion 4. The solar panel 20 is also mounted onto the second face 6 of the bottom flat portion 4 to orient the solar panel 20 away from the target animal's body. This way, the solar panel 20 can stay exposed to solar radiation to generate electricity. Further, the rechargeable battery 10 is positioned within the battery cutout 8 to secure the rechargeable battery 10 inside the battery cutout 8. Since the substrate 2 is structurally a thin board, the battery cutout 8 is required in order to laterally support the rechargeable battery 10. In addition, the rechargeable battery 10 is electrically connected to the solar panel 20 to enable the charging of the rechargeable battery 10 using the electricity generated by the solar panel 20.

As can be seen in FIGS. 1 through 6, the present invention may further comprise a solar charge controller 23 in order to safely charge the rechargeable battery 10. The solar charge controller 23 is used to modify the current and/or voltage of the converted electrical energy in order to safely charge the rechargeable battery 10. The solar charge controller 23 is mounted onto the first face 5 of the bottom flat portion 4. The forementioned arrangement positions the solar charge controller 23 near the solar panel 20 and the rechargeable battery 10 in order to easily transfer the converted electrical energy from the solar panel 20 to the rechargeable battery 10. Furthermore, the solar panel 20 is electrically connected to the rechargeable battery 10 through the solar charge controller 23. Thus, the solar panel 20 can safely charge the rechargeable battery 10 through the solar charge controller 23.

Further, the solar panel 20 of the present invention may include updated and most recent technology such as the low-light solar panel/cell technology. As can be seen in FIGS. 1 through 6, the solar panel 20 of the present invention may also be solar-spray technology. Solar spray technology is a unique technology that allow for spray-on solar cells which are made from nanoparticles that absorb light and conduct electricity along the sprayed surface. The nanoparticles come from two common elements: phosphorus and zinc. The elements are combined and processed into a liquid which can be sprayed onto solar cells. The particles can also be dissolved to form an ink to be used in spray- coating or roll-to-roll printing. The ink is processed into thin films that are responsive to light. Further, the rechargeable battery 10 can be a lithium battery. Note that any energy storage can be utilized in replacement such as a super capacity cell. In addition, updated technology such as quantum glass batteries, glass batteries, motion & vibration charging chips, climate & heat chips, as well as other energy storage technology can be implemented.

As can be seen in FIGS. 1 through 6, the non-contact temperature sensor 21 is utilized to measure and observe the temperature of the target animal's body. To do so, the non-contact temperature sensor 21 is mounted onto the first face 5 of the top flat portion 3 to position the non-contact temperature sensor 21 closer to the target animal's body. In addition, the ear-attachment feature 7 is integrated into the top flat portion 3 and the non-contact temperature sensor 21 is positioned adjacent to the ear-attachment feature 7. Further, the non-contact temperature sensor 21 is electronically connected to the microcontroller 9 and electrically connected to the rechargeable battery 10. Thus, the rechargeable battery 10 is able to power the non-contact temperature sensor 21, and the microcontroller 9 is able to receive temperature measurements from the non-contact temperature sensor 21.

Due to the overall small size of the electronic ear tag 1, the electronic components and the electrical components need to be arranged in such a way that space is maximized without the components obstructing the operation of other components. For example, the microcontroller 9 and the IMU module 22 can be mounted onto the first face 5 of the bottom flat portion 4 to not obstruct the operation of the cellular communication module 25, as can be seen in FIGS. 1 through 6. The IMU module 22 helps track the position and movement of the target animal, so the operation of the IMU module 22 should not be obstructed. In addition, the IMU module 22 is electronically connected to the microcontroller 9 to relay the electronic signals generated by the IMU module 22 to the microcontroller 9 for processing. Furthermore, the IMU module 22 is electrically connected to the rechargeable battery 10 to distribute the power necessary for the operation of the IMU module 22.

As previously discussed, the GNSS module 16 allows the present invention to be tracked using a satellite system for accurate and live tracking of the target animal. As can be seen in FIGS. 1 through 6, the GNSS module 16 may comprise a GNSS antenna 17 and a GNSS receiver 18. The GNSS antenna 17 is used to amplify the signal sent by a GNSS satellite. The GNSS antenna 17 is integrated into the top flat portion 3 in order to be oriented towards the GNSS satellite. The GNSS receiver 18 is mounted onto the first face 5 of the bottom portion in order to be efficiently powered by the rechargeable battery 10. The GNSS receiver 18 is also electronically connected to the microcontroller 9 to enable the transmission of GNSS signals to the microcontroller 9 for processing. Further, the GNSS receiver 18 is electrically connected to the rechargeable battery 10 to distribute the power necessary for the operation of the GNSS receiver 18.

Moreover, the GNSS module 16 may further comprise a GNSS power switch 19. As can be seen in FIGS. 1 through 6, the GNSS power switch 19 can be used to open or close the electrical connection between the GNSS module 16 and the rechargeable battery 10. The GNSS power switch 19 is mounted onto the first face 5 of the bottom flat portion 4. The forementioned arrangement of the GNSS power switch 19 allow for close positioning to the GNSS receiver 18 and the rechargeable battery 10. Furthermore, the rechargeable battery 10 is electrically connected to the GNSS receiver 18 through the GNSS power switch 19. Thus, the electrical connection between the GNSS receiver 18 and the rechargeable battery 10 can be opened or closed through the GNSS power switch 19. In addition, the GNSS power switch 19 opens the electrical connection between the GNSS receiver 18 and the rechargeable battery 10 in order to conserve energy when the present invention is not in use or in idle mode.

As can be seen in FIGS. 1 through 6, the wireless communication module 11 may further comprise a communication antenna 12 and a communication transmitter 13. The communication antenna 12 is used to amplify the signal sent by the wireless communication module 11. The communication transmitter 13 is used to send a signal to a central network such as, but not limited to, a wireless network. The communication antenna 12 is integrated into the top flat portion 3 in order to optimize the signal sent by the communication transmitter 13. The communication transmitter 13 is mounted onto the first face 5 of the bottom flat portion 4. The forementioned arrangement positions the communication transmitter 13 to be efficiently powered by the rechargeable battery 10. Furthermore, the communication transmitter 13 is positioned adjacent to the communication antenna 12 in order to minimize the power loss between the communication antenna 12 and the communication transmitter 13.

In addition, the wireless communication module 11 may further comprise a communication power switch 14. As can be seen in FIGS. 1 through 6, the communication power switch 14 can be used to open or close the electrical connection between the wireless communication module 11 and the rechargeable battery 10. The communication power switch 14 is mounted onto the first face 5 of the bottom flat portion 4 which allow the communication power switch 14 to be positioned closely to the communication transmitter 13 and the rechargeable battery 10. In addition, the rechargeable battery 10 is electrically connected to the communication transmitter 13 through the communication power switch 14. Thus, the electrical connection between the communication transmitter 13 and the rechargeable battery 10 can be opened or closed through the communication power switch 14. Moreover, the communication power switch 14 may open the electrical connection between the wireless communication module 11 and the rechargeable battery 10 when the present invention is not in use in order to conserve energy.

Further, in some embodiments, the communication antenna 12 further comprises an elongated antenna body 15 which is oriented in a specific manner in order to establish optimal connection between the wireless communication module 11 and a central network, as can be seen in FIGS. 1 through 6. The central axis 38 of the elongated antenna body 15 is oriented at an acute angle 40 with a sagittal plane 39 of the substrate 2 in order to establish the optimal communication.

As can be seen in FIGS. 1 through 6, the present invention may further comprise at least one light indicator 24 in order for an individual to track a herd animal in dark environments. The at least one light indicator 24 is preferably an LED light, however different types of lights can be implemented. The at least one light indicator 24 is mounted onto the first face 5 of the bottom flat portion 4. The positioning of the at least one light indicator 24 near the rechargeable battery 10 is in order to establish a lower- power electrical connection. Furthermore, the at least one light indicator 24 is electrically connected to the rechargeable battery 10 and is electronically connected to the microcontroller 9. Thus, the rechargeable battery 10 is able to power the at least one light indicator 24 and the microcontroller 9 is able to manage and control the at least one light indicator 24.

As can be seen in FIGS. 1 through 6, the present invention may further comprise an initialization circuit 35 and an optical power switch 36. The initialization circuit 35 and optical power switch 36 are utilized to initialize and turn on the present invention only after the exposure of solar energy. The initialization circuit 35 and the optical power switch 36 are mounted onto the first face 5 of the bottom flat portion 4. The positioning placement of the initialization circuit 35 and the optical power switch 36 near the rechargeable battery 10 allow for the establishment of a low-powered electrical connection. Furthermore, the initialization circuit 35 is electrically connected to the rechargeable battery 10 by means of the optical power switch 36. Thus, the optical power switch 36 can open or close the electrical connection between the initialization circuit 35 and the rechargeable battery 10. Furthermore, the electrical connection between the initialization circuit 35 and the rechargeable battery 10 is closed by the optical power switch 36 when the optical power switch 36 is exposed to solar energy. The forementioned components interaction with one another allow for the power of the rechargeable battery 10 to be conserved until the present invention is unpackaged and ready to use.

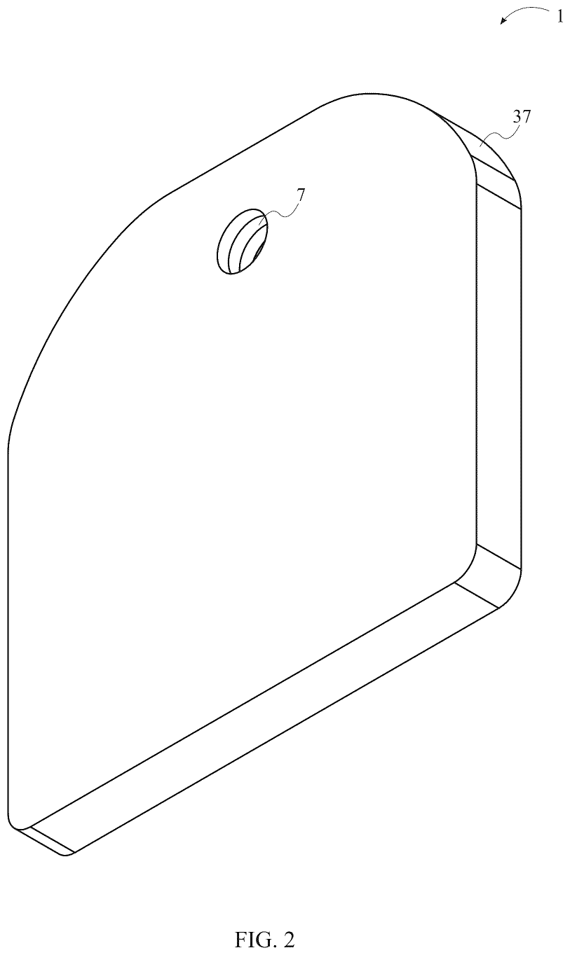

As can be seen in FIGS. 1 and 2, the present invention further comprises a casing 37 in order to protect and conceal the electronical components of the present invention. The electronic ear tag 1 is positioned within the casing 37 so that the casing 37 encloses all components supported by the substrate 2. In other words, the substrate 2, the microcontroller 9, the rechargeable battery 10, the wireless communication module 11, and the GNSS module 16 are protected and concealed by the casing 37. On the other hand, the solar panel 20, the camera module 29, the microphone 33, and the speaker 34 are positioned external to the casing 37. This way, the solar panel 20 can effectively receive solar energy, the camera module 29 can capture the surroundings, the microphone 33 can pick up surrounding sounds, and the speaker 34 can output sounds. Furthermore, the casing 37 is hermetically connected around the solar panel 20, the camera module 29, and the two-way audio communication system 32 in order to be fully secured to the substrate 2.

In addition, the casing 37 is preferably made of thermoplastic elastomer material in order to form a gasket around the solar panel 20. In the preferred embodiment, the substrate casing 37 can be made of polycarbonate material. The polycarbonate material is infused with an ultra-violet resistance material over the casing 37. It is important to note that there is no seal around the edges of the solar panel 20 due to the polycarbonate housing unit, but the solar cell area is non-UV resistant material that is infused into the hardware of the casing 37. In addition, every exterior portion of the present invention can be covered/made with UV resistant material besides the solar cell area.

In the preferred embodiment, the present invention is utilized as a monitoring system for livestock. The present invention can monitor a wide range of features and characteristics. Features include, but are not limited to, positioning, rewinding past movements, geofencing features, animal health, breeding, birthing, temperature of body via thermometer, menstrual cycle, heartbeat and lung monitoring with stethoscope, precession movements, and food/water intake with accelerometer, illness detection, and health records. The present invention uploads the features, characteristics, and information to a custom interface software application. The initialization process for turning the device on includes a scanner code and chip-like codes that the user can scan using a smart device such as a smartphone. Moreover, the present invention can also be utilized for grazing data to assist and enhance the planting of crops. Furthermore, the present invention can also use other methods like a pull-out tab for turning on.

In the preferred embodiment, the present invention is said to attach to the target animal's ear. It is clearly understood that the present invention can also adhere to the tail of an animal. In addition, the present invention can attach to an animal by means of attaching to a collar or other animal accessories. Other methods attachment methods to an animal or object are possible and the said methods does not limit the spirit and scope of the present invention.

In the preferred embodiment, the present invention allows for connectivity using a gateway device and communicating directly to satellite from a base station or a gateway. The present invention connectivity is able to utilize direct to satellite from base stations and gateways. The forementioned connectivity allow for people to utilize the present invention in areas with no cellular service.

In the preferred embodiment, the present invention utilizes a wide range of technological communication systems and methods for upgrading, updating, and servicing of the hardware and the software. Communication systems and methods include, but are not limited to, Firmware over-the-air (FOTA), Over the Air Service Provisioning (OTASP), Over the Air Provisioning (OTAP), Over the Air Parameter Administration (OTAPA), Wireless Access Point (WAP), Multimedia Messaging Service (MMS), Over the Air (OTA) via short message services, Open Mobile Alliance (OMA), Artificial Intelligence (AI), and device/software utilizing AI. The present invention may use other forms of communication systems and methods that has not been specifically listed as a form of data transfer/communication system.

Note that explanation of the present invention to be utilized as tracking device for an animal or object is not intended to limit the spirit and scope of the present invention. Thus, the present invention can be utilized as a GNSS device tracker for any desired object, equipment, animal, person, etc. In addition, the present invention has been described and explained with the usage of a wireless network but is not intended to be limited to only wireless network as the present invention can be used by any type of network or system including, but not limited to, LPWAN, wireless, satellite, Wi-Fi, etc. For example, the connectivity system that can be used can be wireless narrowband-Internet of Things (NB-IOT) compatible and Long-Term Evolutions for Machines (LTE-M) compatible. In addition, satellite connectivity may include technology such as Globalstar network. Furthermore, the present invention is not limited to GNSS, as the ability to utilize Global Positioning System (GPS) is also available. Furthermore, the present invention is not limited to only running when needed. The present invention can send a location fix in real-time and can also slow down location fixes when the device is low on power due to less availability of sunlight as the IMU module 22 runs nearly all the time.

Although the invention has been explained in relation to its preferred embodiment, it is to be understood that many other possible modifications and variations can be made without departing from the spirit and scope of the invention.

What is claimed is:

1. A solar-powered GNSS SIM chip device for tracking and monitoring animals and assets comprising:
an electronic ear tag;
a cellular communication module;
a camera module;
an electronic stethoscope;
a radio-frequency identification (RFID) scannable chip;
a two-way audio communication system;
the electronic ear tag comprising a substrate, a microcontroller, a rechargeable battery, a wireless communication module, a global navigation satellite system (GNSS) module, a solar panel, a non-contact temperature sensor, and an inertial measurement unit (IMU) module;
the substrate comprising a top flat portion, a bottom flat portion, and an ear-attachment feature;
the top flat portion and the bottom flat portion each comprising a first face and a second face;
the substrate, the microcontroller, the rechargeable battery, the wireless communication module, the GNSS module, the solar panel, the non-contact temperature sensor, and the IMU module being operatively coupled amongst each other; and
the cellular communication module, the camera module, the IMU module, the electronic stethoscope, the RFID scannable chip, and the two-way audio communication system being operatively integrated into the electronic ear tag.

2. The solar-powered GNSS SIM chip device for tracking and monitoring animals and assets as claimed in claim 1 comprising:
the cellular communication module comprising a cellular antenna, a cellular transceiver, and a subscriber identity module (SIM) chip;
the cellular antenna being integrated into the top flat portion;
the cellular transceiver and the SIM chip being mounted onto the first face of the bottom flat portion;
the cellular transceiver and the SIM chip being electronically connected to the microcontroller;
the cellular transceiver being electronically connected to the cellular antenna; and
the cellular transceiver, the SIM chip, and the microcontroller being electrically connected to the rechargeable battery.

3. The solar-powered GNSS SIM chip device for tracking and monitoring animals and assets as claimed in claim 1 comprising:
the camera module being mounted onto the second face of the top flat portion;
the camera module being electronically connected to the microcontroller; and
the camera module and the microcontroller being electrically connected to the rechargeable battery.

4. The solar-powered GNSS SIM chip device for tracking and monitoring animals and assets as claimed in claim 1 comprising:
the electronic stethoscope being mounted onto the first face of the bottom flat portion;
the electronic stethoscope being electronically connected to the microcontroller; and
the electronic stethoscope and the microcontroller being electrically connected to the rechargeable battery.

5. The solar-powered GNSS SIM chip device for tracking and monitoring animals and assets as claimed in claim 1 comprising:
the RFID scannable chip being mounted onto the first face of the bottom flat portion; and
the RFID scannable chip being peripherally positioned on the bottom flat portion.

6. The solar-powered GNSS SIM chip device for tracking and monitoring animals and assets as claimed in claim 1 comprising:
the two-way audio communication system comprising a microphone and a speaker;
the microphone and the speaker being mounted onto the second face of the top flat portion;
the microphone and the speaker being electronically connected to the microcontroller; and
the microphone and the speaker being electrically connected to the rechargeable battery.

7. The solar-powered GNSS SIM chip device for tracking and monitoring animals and assets as claimed in claim 1 comprising:
the substrate comprising a battery cutout;
the solar panel being mounted onto the second face of the bottom flat portion;
the battery cutout traversing through the bottom flat portion;
the rechargeable battery being positioned within the battery cutout; and
the rechargeable battery being electrically connected to the solar panel.

8. The solar-powered GNSS SIM chip device for tracking and monitoring animals and assets as claimed in claim 6 comprising:
the electronic ear tag further comprising a solar charge controller;
the solar charge controller being mounted onto the first face of the bottom flat portion; and
the solar panel being electrically connected to the rechargeable battery through the solar charge controller.

9. The solar-powered GNSS SIM chip device for tracking and monitoring animals and assets as claimed in claim 1 comprising:
the ear-attachment feature being integrated into the top flat portion;
the non-contact temperature sensor being mounted onto the first face of the top flat portion;
the non-contact temperature sensor being positioned adjacent to the ear- attachment feature;
the non-contact temperature sensor being electronically connected to the microcontroller; and
the non-contact temperature sensor being electrically connected to the rechargeable battery.

10. The solar-powered GNSS SIM chip device for tracking and monitoring animals and assets as claimed in claim 1, wherein the microcontroller is mounted onto the first face of the bottom flat portion.

11. The solar-powered GNSS SIM chip device for tracking and monitoring animals and assets as claimed in claim 1 comprising:
the IMU module being mounted onto the first face of the bottom flat portion;
the IMU module being electronically connected to the microcontroller; and
the IMU module being electrically connected to the rechargeable battery.

12. The solar-powered GNSS SIM chip device for tracking and monitoring animals and assets as claimed in claim 1 comprising:
the GNSS module comprising a GNSS antenna and a GNSS receiver;
the GNSS antenna being integrated into the top flat portion;
the GNSS receiver being mounted onto the first face of the bottom flat portion;
the GNSS receiver being electronically connected to the microcontroller; and
the GNSS receiver being electrically connected to the rechargeable battery.

13. The solar-powered GNSS SIM chip device for tracking and monitoring animals and assets as claimed in claim 12 comprising:
the GNSS module further comprising a GNSS power switch;
the GNSS power switch being mounted onto the first face of the bottom flat portion; and
the rechargeable battery being electrically connected to the GNSS receiver through the GNSS power switch.

14. The solar-powered GNSS SIM chip device for tracking and monitoring animals and assets as claimed in claim 1 comprising:
the wireless communication module comprising a communication antenna and a communication transmitter;
the communication antenna being integrated into the top flat portion;
the communication transmitter being mounted onto the first face of the bottom flat portion; and
the communication transmitter being positioned adjacent to the communication antenna.

15. The solar-powered GNSS SIM chip device for tracking and monitoring animals and assets as claimed in claim 14 comprising:
the wireless communication module further comprising a communication power switch;
the communication power switch being mounted onto the first face of the bottom flat portion; and
the rechargeable battery being electrically connected to the communication transmitter through the communication power switch.

16. The solar-powered GNSS SIM chip device for tracking and monitoring animals and assets as claimed in claim 14 comprising:
the communication antenna comprising an elongated antenna body; and
a central axis of the elongated antenna body being oriented at an acute angle with a sagittal plane of the substrate.

17. The solar-powered GNSS SIM chip device for tracking and monitoring animals and assets as claimed in claim 1 comprising:
the electronic ear tag further comprising at least one light indicator;
the at least one light indicator being mounted onto the first face of the bottom flat portion;
the at least one light indicator being electrically connected to the rechargeable battery; and
the at least one light indicator being electronically connected to the microcontroller.

18. The solar-powered GNSS SIM chip device for tracking and monitoring animals and assets as claimed in claim 1 comprising:
an initialization circuit;
an optical power switch;
the initialization circuit and the optical power switch being mounted onto the first face of the bottom flat portion; and
the initialization circuit being electrically connected to the rechargeable battery through the optical power switch.

19. The solar-powered GNSS SIM chip device for tracking and monitoring animals and assets as claimed in claim 1 comprising:
a casing;
the electronic ear tag being positioned within the casing;
the solar panel and the camera module being positioned external to the casing; and
the casing being hermetically connected around the solar panel, the camera module, and the two-way audio communication system.

20. The solar-powered GNSS SIM chip device for tracking and monitoring animals and assets as claimed in claim 19, wherein the casing is made of a thermoplastic elastomer material.
